(19) United States
(12) Patent Application Publication
(10) Pub. No.: US 2013/0240761 A1
(43) Pub. Date: Sep. 19, 2013

(54) SELF-FOCUSING RADIOACTIVE SOURCE DEVICE AND RADIATING APPARATUS EMPLOYING THE SAME

(71) Applicant: Xiangyu Wang, Shanghai (CN)

(72) Inventor: Xiangyu Wang, Shanghai (CN)

(73) Assignee: Shipeng Song, Shanghai (CN)

(21) Appl. No.: 13/877,085

(22) PCT Filed: Aug. 16, 2011
(86) PCT No.: PCT/CN2011/078452

§ 371 Date: Jun. 3, 2013

(30) Foreign Application Priority Data
Sep. 30, 2010 (CN) 201010503147.4

(51) Int. Cl. G21K 5/04

(52) U.S. Cl. CPC G21K 5/04
USPC 250/503.1

(57) ABSTRACT

A self-focusing radioactive source device and a radiating apparatus employing the same are disclosed. The self-focusing radioactive source device includes: a source capsule; a source body disposed in the source capsule; and M radioactive sources arranged in the source body, wherein radioactive rays emitted from the M radioactive sources in the source capsule are focused on a common focus, and wherein M is a natural number greater than 1. The self-focusing radioactive source device and the radiating apparatus can greatly reduce the volume and weight of the source body, obtain a small penumbra and small focus radius, and provide flexible incident angles and wide applications.

This application claims the priority of Chinese patent application number 201010503147.4, filed in the State Intellectual Property Office (SIPO) of the People's Republic of China on Sep. 30, 2010, entitled “Self-focusing Radioactive Source Device and Radiating Apparatus Employing the Same”, the entire contents of which are incorporated herein by reference.

### TECHNICAL FIELD

This invention relates to focusing radiotherapy devices, and more particularly, to a radioactive source device and a radiating apparatus employing the radioactive source device, for use in focusing radiotherapy devices.

### BACKGROUND

Focusing radiotherapy is a mainstream technology in the field of radiotherapy treatments. Performance of a focusing radiotherapy device can be characterized by the following parameters: 1) size of a penumbra formed by radioactive rays emitted from the radioactive sources; 2) coefficient of utilization of the radioactive sources; 3) focus-to-skin ratio (defined as a ratio of radiation dose received by the lesion on the focus to that received by the skin); 4) volume and structural simplicity of the radioactive sources; 5) magnitude of the focal diameter; and 6) degree of automation. A radioactive source device and a radiating apparatus for a focusing radiotherapy device with good performance should have a small penumbra, a high coefficient of utilization of the radioactive sources, a high focus-to-skin ratio, a small focal diameter, a small size and a simple structure, and be equipped with a therapeutic system with a high degree of automation.

Currently, most radiotherapy devices incorporate tens of to hundreds of radioactive sources in a treatment head, where the radioactive sources in source capsules are dispersedly arranged. Such devices have problems in coordinating their designs to meet the criteria of foregoing parameters. For example, in order to obtain a high coefficient of utilization of the radioactive sources, each radioactive source is designed to have a rather large active area, generally having a diameter of about 3.5 mm, which leads to a large penumbra, meaning that the “knife” is not “sharp”, or in other words, the radiation energy of the radioactive sources is not concentrated, so that the treatment efficacy is affected; or the collimating apertures are designed to have a large size, which inevitably leads to an increase of the minimum focal diameter, and as a result, the device is inapplicable to the treatment of lesions that need a small target spot (i.e., a small focal diameter) of radioactive rays, thus narrowing the application of the radiotherapy device. Furthermore,, as for the design with very small collimating apertures for achieving a small focal diameter, since a rather large portion of radioactive rays emitted from the radioactive sources cannot pass through the small collimating apertures to contribute to an effective dose at the target spot, the coefficient of utilization of the radioactive sources as well as the dose at the target spot will be greatly reduced and hence a good treatment effect cannot be obtained.

Nowadays, some manufacturers have succeeded in reducing the active area of radioactive sources to an extent of a diameter of 1 mm. Such design modification enables the radiotherapy device to achieve a great coefficient of utilization of the radioactive sources, a small focal diameter and a small penumbra. However, in order to achieve these beneficial effects, the radiotherapy device must employ up to hundreds of radioactive sources, resulting in a complicated structure of the device, a great difficulty in manufacturing, a large-sized treatment head and a great overall weight. In addition, as the hundreds of radioactive sources are sealed in hundreds of source capsules, the installation and transportation of the device need great effort and a high cost.

### SUMMARY OF THE INVENTION

The present invention is directed to the provision of a self-focusing radioactive source device and a radiating apparatus to achieve a high coefficient of utilization of the radioactive sources, a small penumbra, a simple structure and a small size.

In order to achieve the above objectives, the present invention provides a self-focusing radioactive source device, including: a source capsule; a source body disposed in the source capsule; and M radioactive sources arranged in the source body, wherein radioactive rays emitted from the M radioactive sources are focused at a common focus, and wherein M is a natural number that is greater than 1.

Optionally, the M radioactive sources can be arranged into N groups, and a distance between centers of two closest radioactive sources in any group is not greater than a distance between centers of two closest radioactive sources of any two different groups, where N is a natural number that is greater than 1.

Optionally, the source body can have a shape of cylinder, and the N groups of radioactive sources are arranged on an end surface of the source body and are evenly distributed around a center of the end surface.

Optionally, on the end surface of the source body, radioactive sources of each group are arranged within an externally tangent circle of the group and are evenly distributed around a center of the externally tangent circle.

The present invention also provides a radiating apparatus, including: a self-focusing radioactive source device according to the foregoing description; and a collimator apparatus configured to collimate the radioactive rays emitted from the self-focusing radioactive source device.

Optionally, the collimator apparatus can have a plurality of groups of collimating apertures of different aperture diameters, wherein centerlines of collimating apertures of the same group are focused at a common focus, and wherein at least one of the plurality of groups includes M collimating apertures which are distributed in correspondence with the distribution of the M radioactive sources in the source body. In addition, at least one of the plurality of groups includes N collimating apertures which are distributed in correspondence with the distribution of the N groups of radioactive sources.

Compared to the conventional technologies, the present invention has beneficial effects as follows:

Firstly, in the self-focusing radioactive source device and radiating apparatus employing the self-focusing radioactive source device according to the present invention, since multiple radioactive sources are all sealed in a single source capsule, and radioactive rays from all these radioactive sources are configured to be focused at a common focus, the self-focusing radioactive source device can be installed and transported in a simpler and more convenient way. Moreover, both the self-focusing radioactive source device and the radiating apparatus have a greatly reduced size, a simpler structure and hence a much smaller weight.

Furthermore, in the radiating apparatus including the self-focusing radioactive source device and a collimator apparatus, the collimator apparatus has a plurality of groups of collimating apertures of different aperture diameters, and at least one of the plurality of groups includes M collimating apertures which are distributed in correspondence with the distribution of the M radioactive sources in the source body; since the collimating apertures have a smaller diameter, a smaller focal diameter can be achieved, and a smaller penumbra can be obtained without sacrificing the coefficient of utilization of the radioactive sources. Moreover, as among the multiple groups of collimating apertures, there may also be at least one group which includes N collimating apertures that have a greater diameter and are distributed in correspondence with the distribution of the N groups of radioactive sources, different sizes of focal diameters and a smaller penumbra can be obtained with the coefficient of utilization of the radioactive sources being not greatly reduced. In addition, although the radiating apparatus employs a large number of radioactive sources in order to maintain a high focus-to-skin ratio, it has a greatly reduced size and a simpler structure, and thus can be more easily produced, compared to a conventional radiating apparatus employing the same number of radioactive sources. Further, in an overall point of view, as the radiating apparatus of the present invention has a greatly reduced weight, it can be conveniently installed and its movement can be easily controlled, thus making the adjustment of incidence angles more flexible, and the range of applications has been greatly extended.

### BRIEF DESCRIPTION OF THE DRAWINGS

FIG. 1 is a perspective view of a self-focusing radioactive source device according to an embodiment of the present invention.

FIG. 2 is a plan view of the self-focusing radioactive source device of FIG. 1 from the side of an end surface farther to a common focus.

FIG. 3 is a schematic perspective view of a radiating apparatus according to an embodiment of the present invention.

### DETAILED DESCRIPTION

The present invention provides a self-focusing radioactive source device and a radiating apparatus employing the self-focusing radioactive source device. The self-focusing radioactive source device includes multiple radioactive sources which are all sealed in a single source capsule. This allows the device to be installed and transported in a simpler and more convenient way. In contrast, most existing radioactive source devices include multiple radioactive sources, each of which is individually sealed in a source capsule, thus requiring repeated operations during their installation and transportation. Moreover, as the self-focusing radioactive source device has a greatly reduced volume and a simpler structure, and hence a much smaller weight, the radiating apparatus of the present invention also has a greatly reduced volume, a simpler structure, and a much smaller weight, compared to those of the prior art.

Furthermore, in the radiating apparatus including the self-focusing radioactive source device and a collimator apparatus, the collimator apparatus has a plurality of groups of collimating apertures of different aperture diameters, and at least one of the plurality of groups includes M collimating apertures which are distributed in correspondence with the distribution of the M radioactive sources in the source body; a smaller focal diameter can be achieved, and a smaller penumbra can be obtained without sacrificing the coefficient of utilization of the radioactive sources. Moreover, as among the multiple groups of collimating apertures, there may also be at least one group which includes N collimating apertures and are distributed in correspondence with the distribution of the N groups of radioactive sources, different sizes of focal diameters and a smaller penumbra can be obtained with the coefficient of utilization of the radioactive sources being not greatly reduced. In addition, although the radiating apparatus employs a large number (typically greater than 100) of radioactive sources in order to maintain a high focus-to-skin ratio, it has a greatly reduced size and a simpler structure, and thus can be more easily produced, compared to a conventional radiating apparatus employing the same number of radioactive sources. Further, in an overall point of view, as the radiating apparatus of the present invention has a greatly reduced weight, it can be conveniently installed and its movement can be easily controlled, thus making the adjustment of incidence angles more flexible.

In specific embodiments of the present invention, a self-focusing radioactive source device includes: a source capsule; a source body disposed in the source capsule; and M radioactive sources arranged in the source body. Radioactive rays emitted from the M radioactive sources are focused at a common focus. Each of the radioactive sources may be disposed in a source hole. All the source holes have their centerlines focused at a common focus (which is configured at the target lesion in a radiotherapy of tumor), such that radioactive rays emitted from the M radioactive sources can also be focused at the common focus. Wherein M is a natural number that is greater than 1.

In order for those skilled in the art to further understand the present invention, example embodiments will be described below with reference to the accompanying drawings.

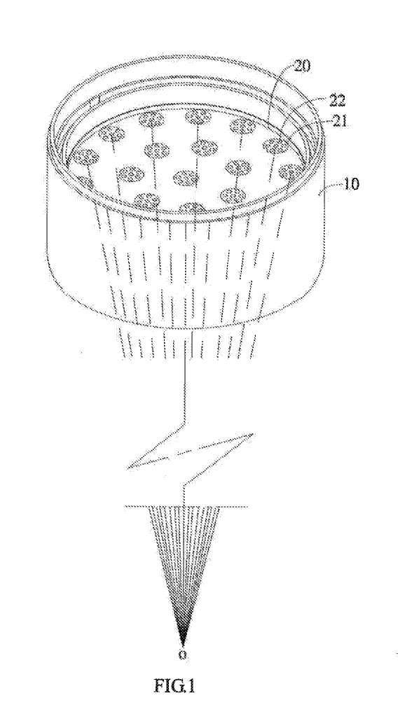

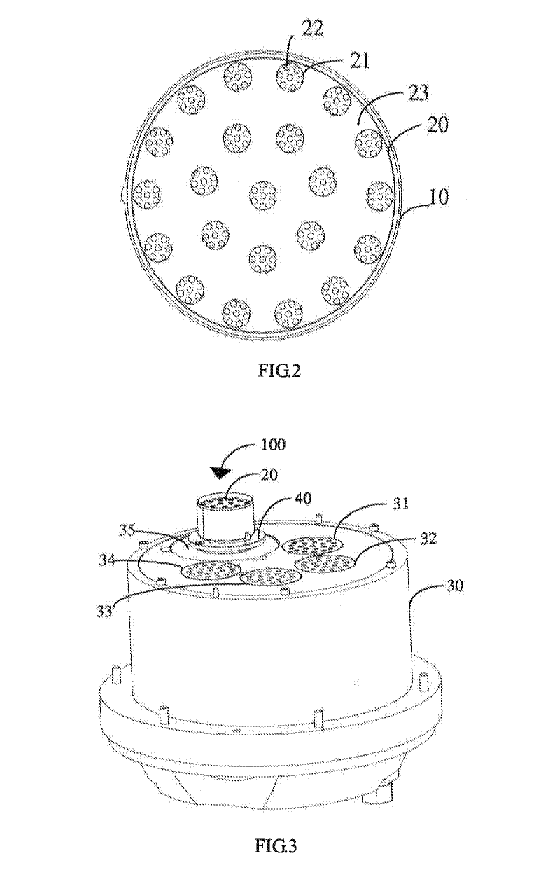

FIG. 1 is a perspective view of a self-focusing radioactive source device according to an embodiment of the present invention. As shown in FIG. 1, also referring to FIG. 2, in this embodiment, the self-focusing radioactive source device includes: a source capsule 10; a source body 20 disposed in the source capsule 10, the source body 20 having 154 source holes 22; and 154 radioactive sources (i.e., M=154), which are respectively disposed in the 154 source holes 22. Extensions of the centerlines of the source holes 22 intersect at a common focus O, so that radioactive rays emitted from the 154 radioactive sources can also be focused at the common focus O. The 154 source holes 22 are arranged into 22 groups (i.e., N=22), and thus the 154 radioactive sources disposed in the respective source holes 22 are also arranged into 22 groups (i.e., N=22). Moreover, a distance between centers of two closest radioactive sources in any group is not greater than a distance between centers of two closest radioactive sources of any two different groups. In specific embodiments, radioactive sources in each group may be evenly distributed, i.e., the distance between centers of every two neighboring radioactive sources in one group is identical. Moreover, the 22 groups of radioactive sources may also be evenly distributed, i.e., the distance between centers of every two neighboring groups is also identical. In more specific embodiments, a distance between centers of any two radioactive sources belonging to a same group is not greater than (i.e., less than or equal to) a distance between centers of any two radioactive sources each belonging to a different group, and radioactive rays emitted from the 154 radioactive sources are focused at the common focus O. In specific embodiments, radioactive sources that are disposed in the source holes are Co-60.

In more specific embodiments, the M radioactive sources are arranged into N groups, where a distance between centers of two closest radioactive sources in any group is not greater than a distance between centers of two closest radioactive sources of any two different groups, and where N is a natural number that is greater than 1. By arranging the radioactive sources into groups, different diameters of target spots can be obtained after the self-focusing radioactive source device is aligned with a collimator apparatus. Wherein, those groups including M collimating apertures have an aperture diameter smaller than that of those groups including N collimating apertures, a small target spot can be obtained. Those groups including N collimating apertures are configured such that the N collimating apertures are aligned with the N groups of radioactive sources and thus all radioactive rays emitted from a same group of radioactive source can pass through a corresponding collimating aperture, and thereby forming a large target spot. Such design of the self-focusing radioactive source device can greatly increase the dose at the common focus and achieve a higher focus-to-skin ratio.

It is noted that although radioactive sources are not shown in the figures, as they are disposed in the respective source holes, the distribution of the source holes can represent the distribution of the radioactive sources. Therefore, in the descriptions below, the distribution of the radioactive sources are represented by the distribution of the source holes. Moreover, although there is a radioactive source disposed in each source hole in the foregoing example embodiments, the present invention is not limited to it, and in practical applications, the number of source holes may be greater than that of the radioactive sources, i.e., the case that there is no radioactive source disposed in some of the source holes.

In some specific embodiment, the source body 20 may have a shape of cylinder and the 22 groups of radioactive sources are arranged on an end surface of the source body 20 and are evenly distributed around a center of the end surface. Walls that separate the source holes of each group may be very thin, so that the size of the source body 20 can be greatly reduced. Moreover, test results have proved that when the axial dimension of a collimator apparatus reaches greater than 180 mm, radioactive rays can produce a very small penumbra. Although the source body has a shape of cylinder in the above preferred embodiment, the present invention is not limited to it, and the source body may have another shape, such as a shape of truncated cone.

FIG. 2 is a plan view of the self-focusing radioactive source device of FIG. 1 from the side of an end surface of the source body 20. As shown in FIG. 2, in this preferred embodiment, the source body 20 has 22 groups of source holes 22. As each group includes 7 source holes 22, the total number of source holes 22 is 154. In other embodiments, the number of groups of source holes 22 may not be 22, and the number of source holes 22 of each group may not be 7. Instead, these numbers may be determined by a desired radiation dose based on which radiotherapy can be achieved. In the embodiment shown in FIG. 2, on an end surface 23 of the source body 20, which is farther to the common focus O, the 22 groups of source holes 22 are evenly distributed, with one group arranged at the center of the end surface, six groups arranged on an inner circle centered by the center of the end surface, and fifteen groups arranged on an outer circle also centered by the center of the end surface. In more specific embodiments, radioactive sources of each group are all arranged within an externally tangent circle of the group and are evenly distributed around a center of the externally tangent circle. That is, in each group, except a source hole 22 arranged at the center of the group, all other source holes 22 have a common externally tangent circle 21 and are evenly distributed about the center of the externally tangent circle 21. In the embodiment shown in FIG. 2, six source holes 22 are evenly distributed about the center of the externally tangent circle 21.

In the present invention, dimension of the source body, intervals between and sizes of the radioactive sources may be adjusted according to parameters such as the active area and specific radioactivity of the radioactive sources, and needed dose for the target therapy area. In one embodiment, diameter of the source body 20 may be 66.5 mm, diameter of the externally tangent circle 21 may be 5.5 mm, and diameter of the source holes 22 may be 1 mm, so that the corresponding self-focusing radioactive source device can have a much smaller size than conventional radioactive source devices employing multiple radioactive sources.

Based on the above described self-focusing radioactive source device, the present invention also provides a radiating apparatus, specific embodiments of which will be described in detail below with reference to accompanying drawings.

FIG. 3 is a schematic perspective view of a radiating apparatus according to an embodiment of the present invention. The radiating apparatus is for use in radiotherapy devices. In this embodiment, the collimator apparatus of the radiating apparatus has been modified according to the structure of the radioactive source body. The radiating apparatus of the present invention includes: a self-focusing radioactive source device according to the above description, which is the self-focusing radioactive source device 100 with a source body 20 according to the above description as shown in the embodiment of FIG. 3; and a collimator apparatus 30 configured to collimate radioactive rays emitted from the source body 20.

The collimator apparatus 30 may have a plurality of groups of collimating apertures of different aperture diameters, wherein centerlines of collimating apertures of the same group are focused at a common focus. At least one of the plurality of groups includes M collimating apertures which are distributed in correspondence with the distribution of the M radioactive sources in the source body. More specifically, each collimating-aperture group may include a plurality of collimating apertures, centerlines of all of which are focused at a common focus. In one embodiment, except one group including 154 collimating apertures having a smallest aperture diameter with the 154 collimating apertures distributed in correspondence with how the 154 source holes are distributed in the source body 20, each of the rest groups includes N collimating apertures. In more specific embodiments, each of the rest groups may include 22 collimating apertures which are distributed in correspondence with the distribution of the 22 groups of source holes in the source body 20. Once the source holes in the source body 20 are aligned with one of the groups of collimating apertures, the collimator apparatus will collimate radioactive rays emitted from the source body. Moreover, an aperture diameter of the group that includes M (i.e., 154) collimating apertures is smaller than an aperture diameter of the group that includes N (i.e., 22) collimating apertures.

In some other embodiments, the number of collimating-aperture groups that include M collimating apertures may be greater than I and can be altered according to practical needs. Similarly, the number of collimating-aperture groups that include N collimating apertures may also be greater than 1.

In the embodiment shown in FIG. 3, the collimator apparatus 30 includes 5 groups of collimating apertures, namely a first group 31, a second group 32, a third group 33, a fourth group 34 and a fifth group 35, each group having centerlines of the collimating apertures focused at a common focus. Among the 5 groups, the first group 31 has the smallest aperture diameter and has 154 collimating apertures which are distributed in correspondence with the distribution of the 154 source holes in the source body 20, such that when collimating apertures of the first group 31 are aligned with the source holes of the source body 20, a smallest focal diameter can be achieved for the treatment of small-sized lesions. Each of the second group 32, the third group 33, the fourth group 34 and the fifth group 35 includes 22 collimating apertures which are distributed in correspondence with the distribution of the 22 groups of source holes on the source body 20, thus making them suitable for use in the treatment of large-sized lesions. In practical applications, a group with a proper aperture diameter can be selected from these collimating-aperture groups that have different aperture diameters to collimate radioactive rays emitted from the source body 20. It is noted that although the number of collimating-aperture groups of the collimator apparatus 30 is five in the embodiments described above, the present invention is not limited to it, and the collimator apparatus 30 may include any number of groups of collimating apertures according to the requirement of practical applications. Moreover, the aperture diameter of each group may also be set to any value according to the requirement of practical applications. Besides, the number of collimating apertures may be set according to the number of source holes in the source body 20.

The collimator apparatus 30 may be coupled to the self-focusing radioactive source device 100 via a rotating component 40, so that the collimator apparatus 30 can be driven to rotate relative to the self-focusing radioactive source device 100 to achieve the objective of switching diameters of the collimating apertures.

Although the collimator apparatus 30 has a shape of cylinder in the above described preferred embodiments, the present invention is not limited to it. The collimator apparatus 30 may have another shape, such as a shape of truncated cone or a shape of regular polyhedron column.

As indicated above, the self-focusing radioactive source device and radiating apparatus of the present invention can get a higher coefficient of utilization of the radioactive sources, a smaller penumbra, a greatly reduced volume and weight, a common focus with a smaller diameter, and adaptation to diseases with various sizes of lesions.

While specific embodiments have been presented in the foregoing description, they are not intended to limit the invention in any way. Those skilled in the art can make various modifications and variations without departing from the scope of the invention. Thus, it is intended that the present invention cover all such modifications and variations provided they come within the scope of the appended claims and their equivalents.

1. A self-focusing radioactive source device, comprising: a source capsule; a source body disposed in the source capsule; and M radioactive sources arranged in the source body, wherein radioactive rays emitted from the M radioactive sources are focused at a common focus, and wherein M is a natural number that is greater than 1.

2. The self-focusing radioactive source device according to claim 1, wherein the M radioactive sources are arranged into N groups, wherein a distance between centers of two closest radioactive sources in any group is not greater than a distance between centers of two closest radioactive sources of any two different groups, and wherein N is a natural number that is greater than 1.

3. The self-focusing radioactive source device according to claim 2, wherein the source body has a shape of cylinder, and wherein the N groups of radioactive sources are arranged on an end surface of the source body and are evenly distributed around a center of the end surface.

4. The self-focusing radioactive source device according to claim 3, wherein on the end surface of the source body, radioactive sources of each group are arranged within an externally tangent circle of the group and are evenly distributed around a center of the externally tangent circle.

5. A radiating apparatus comprising:
the self-focusing radioactive source device according to claim 3; and
a collimator apparatus configured to collimate the radioactive rays emitted from the self-focusing radioactive source device.

6. The radiating apparatus according to claim 5, wherein the collimator apparatus has a plurality of groups of collimating apertures of different aperture diameters, wherein centerlines of collimating apertures of the same group are focused at a common focus, and wherein at least one of the plurality of groups includes M collimating apertures which are distributed in correspondence with the distribution of the M radioactive sources in the source body.

7. The radiating apparatus according to claim 5, wherein in the collimator apparatus, at least one of the plurality of groups includes N collimating apertures which are distributed in correspondence with the distribution of the N groups of radioactive sources.

8. The radiating apparatus according to claim 7, wherein each one of the groups including M collimating apertures has an aperture diameter that is smaller than the aperture diameter of any one of the groups including N collimating apertures.

9. The radiating apparatus according to claim 6, wherein in the collimator apparatus, at least one of the plurality of groups includes N collimating apertures which are distributed in correspondence with the distribution of the N groups of radioactive sources.

10. The radiating apparatus according to claim 9, wherein each one of the groups including M collimating apertures has an aperture diameter that is smaller than the aperture diameter of any one of the groups including N collimating apertures.

11. A radiating apparatus comprising:
the self-focusing radioactive source device according to claim 4; and
a collimator apparatus configured to collimate the radioactive rays emitted from the self-focusing radioactive source device.

12. The radiating apparatus according to claim 11, wherein the collimator apparatus has a plurality of groups of collimating apertures of different aperture diameters, wherein centerlines of collimating apertures of the same group are focused at a common focus, and wherein at least one of the plurality of groups includes M collimating apertures which are distributed in correspondence with the distribution of the M radioactive sources in the source body.

13. The radiating apparatus according to claim 11, wherein in the collimator apparatus, at least one of the plurality of groups includes N collimating apertures which are distributed in correspondence with the distribution of the N groups of radioactive sources.

14. The radiating apparatus according to claim 13, wherein each one of the groups including M collimating apertures has an aperture diameter that is smaller than the aperture diameter of any one of the groups including N collimating apertures.

15. The radiating apparatus according to claim 12, wherein in the collimator apparatus, at least one of the plurality of groups includes N collimating apertures which are distributed in correspondence with the distribution of the N groups of radioactive sources.

16. The radiating apparatus according to claim 15, wherein each one of the groups including M collimating apertures has an aperture diameter that is smaller than the aperture diameter of any one of the groups including N collimating apertures.
